(19) United States
(12) Patent Application Publication
(10) Pub. No.: US 2005/0182622 A1
(43) Pub. Date: Aug. 18, 2005

(54) Information processing device and information processing method

(75) Inventors: Katsuhiko Kawasaki, Tokyo (JP); Hiroki Yamamoto, Tokyo (JP); Kenichiro Nakagawa, Tokyo (JP); Tsuyoshi Yagisawa, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/955,498

(22) Filed: Sep. 29, 2004

(30) Foreign Application Priority Data
Oct. 3, 2003 (JP) 2003-345892

(51) Int. Cl. G10L 19/14

(52) U.S. Cl. 704/225

(57) ABSTRACT

A state of a system, such as a printer or wireless device set, is monitored and sound information corresponding to the state of the system is output. An output mode for output sound information can be set by a user to a mode (e.g., silent mode) in which the sound information output manner is controlled by the user. When the sound information corresponding to the operation state of the system is acquired, if the output mode for the sound information is set to the silent mode, the acquired sound information is silenced, and the silenced sound information is output.

This application claims priority from Japanese Patent Application No. 2003-345892 filed Oct. 3, 2003, which is hereby incorporated by reference herein.

### BACKGROUND OF THE INVENTION

1. Field of the Invention

The present invention relates to information processing devices and information processing methods for outputting sound information.

2. Description of the Related Art

Conventional sound guidance systems in which automatic volume control is provided are well known. The volume of the sound guidance system is automatically increased or decreased based on surrounding ambient and background noise. An example of such a conventional system is disclosed in Japanese Patent Laid-Open No. 5-332778.

Similarly, in an elevator announcement system, a signal is received from a noise level detection unit to detect the elevator noise level during a normal operation state, and when a designated state is reached, a sound synthesis instruction and a volume designation signal are output to a sound synthesis control unit and the sound synthesis control unit that receives the instruction outputs the volume designation signal to a volume control unit in accordance with data in a knowledge data unit to optimally control the message output from a speaker. An example is disclosed in Japanese Patent Laid-Open No. 8-239174.

However, since the methods described above automatically control the volume of sound in accordance with conditions not controllable by users, users cannot freely set the speed, quality and length of guidance of the output sound.

The same can be said for wireless device sets provided with a vibration mode, for example. Users cannot control the volume, sound quality, speech rate, or speech details of the so-called melody that signals an incoming call, a ringing sound, or read out mail.

### SUMMARY OF THE INVENTION

In order to solve one or more of the above-described drawbacks and disadvantages of conventional systems, an information processing device and method is provided. An advantage of the present invention is that when a silent mode is set for the system, the sound guidance information that is output in accordance with an operation state of the system is controlled in a manner desired by the user.

According to one aspect of the present invention, an information processing device includes a monitoring unit for monitoring an operation state of a system; an acquisition unit for acquiring sound information corresponding to the operation state of the system; an output unit for outputting the acquired sound information; a setting unit for setting an output mode for the sound information output from the output unit to a silent mode; and a silencing unit for silencing the sound information acquired from the acquisition unit when the output mode for the sound information is set to the silent mode. When the output mode for the sound information is set to the silent mode, the output unit outputs the silenced sound information.

According to another aspect of the present invention, an information processing method for monitoring an operation state of a system and for outputting sound information corresponding to the operation state of the system includes a setting step of setting an output mode for the sound information to be output to a silent mode; an acquisition step of acquiring the sound information corresponding to the operation state of the system; a silencing step of silencing the acquired sound information when the output mode for the sound information is set to the silent mode; and an output step of outputting the silenced sound information.

According to another aspect of the present invention, a program is provided for causing a computer for monitoring an operation state of a system and for outputting sound information corresponding to the operation state of the system to execute the processing steps described above.

According to another aspect of the present invention, a computer-readable recording medium is provided for storing the program described above.

According to yet another aspect of the present invention, a method for outputting sound guidance information from a device, such as a printer or wireless communication set, is disclosed. The sound guidance information guides a user to perform tasks on the device or to indicate an event occurrence on the device. The method includes receiving the sound guidance information, and then receiving user input to select an output mode for the sound guidance information. Upon user selection, the sound guidance information is output from the device in the selected output mode, which is configured to control the manner in which the sound guidance information is output. The sound guidance information can be output by reducing the volume of the sound guidance information output from the device, increasing output speed of sound guidance information output from the device, reducing the length of the sound guidance information output from the output device, outputting the sound guidance information as breathed sound, and inhibiting low-frequency components of the sound guidance information output from the device.

Further features and advantages of the present invention will become apparent from the following description of the embodiments with reference to the attached drawings.

### BRIEF DESCRIPTION OF THE DRAWINGS

FIG. 1 is a block diagram of an information processing device according to an embodiment of the present invention.

FIG. 2 is a flowchart of a process for performing sound synthesis and for outputting sound during operation of a printer unit according to an embodiment of the present invention.

FIG. 3 is a graph showing characteristics of an exemplary low-frequency inhibition filter of an information processing device according to an embodiment of the present invention.

FIG. 4 is a block diagram of an information processing device according to an embodiment of the present invention.

### DETAILED DESCRIPTION OF EMBODIMENTS

Embodiments of the present invention will be described with reference to the drawings.

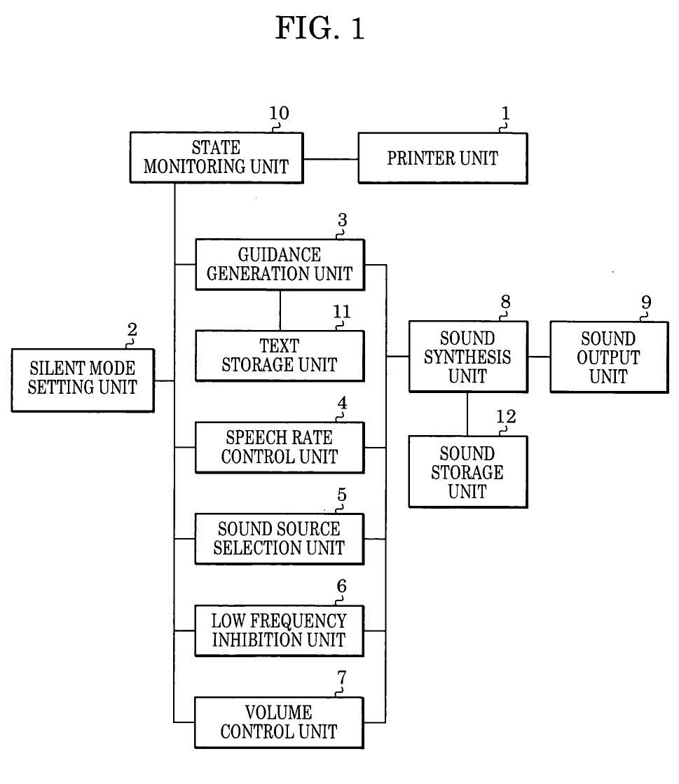

FIG. 1 is a block diagram of an information processing device according to an embodiment of the present invention. In FIG. 1, by way of example, a printer with a sound guidance function is illustrated. Referring to FIG. 1, the printer provided with the information processing device includes a printer unit 1, a silent mode setting unit 2, a guidance generation unit 3, a speech rate control unit 4, a sound source selection unit 5, a sound synthesis unit 8, a low-frequency inhibition unit 6, a volume control unit 7, a sound output unit 9, a state monitoring unit 10, a text storage unit 11, and a sound storage unit 12.

In FIG. 1, the printer unit 1 is conventional printer. It may be separate from or integrated as a single unit with the information processing device of the present invention.

The silent mode setting unit 2 allows users to set the volume, the sound source, the speech rate, the speech details and the like of sound guidance information. In this embodiment, when a silent mode is set by the silent mode setting unit 2, the guidance generation unit 3 generates guidance information for the silent mode, and the sound synthesis unit 8 synthesizes the sound of the guidance information. Also, the speech rate control unit 4, the sound source selection unit 5, the low-frequency inhibition unit 6, or the volume control unit 7 controls sound synthesis processing performed by the sound synthesis unit 8, and synthesizes the sound guidance information silenced by the sound synthesis unit 8. The sound synthesis unit 8 is connected to the sound storage unit 12 for storing various sound data necessary for sound synthesis. The sound output unit 9 is, for example, a speaker, and outputs normal sound guidance information in a normal mode and outputs silenced sound guidance information in a silent mode.

The state monitoring unit 10 monitors the state of the printer unit 1. Note that the silent mode setting unit 2 may be incorporated in the printer. Alternatively, the silent mode setting unit 2 may be software installed within a computer connected to the printer.

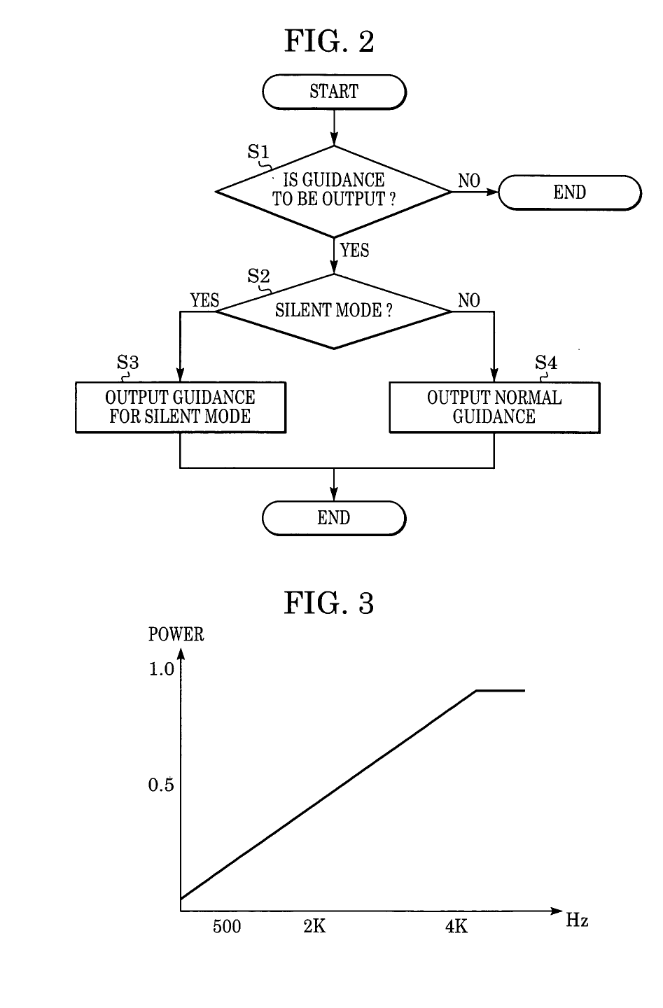

FIG. 2 is a flowchart of a process for performing sound synthesis and for outputting sound during operation of the printer unit 1 shown in FIG. 1 in accordance with an embodiment of the present invention. Before this process, a user may set the silent mode by using the silent mode setting unit 2.

The state monitoring unit 10 monitors the printer unit 1 to determine whether sound guidance information to be output from the sound output unit 9 exists (step S1). If sound guidance information is to be output (if the determination in step S1 is affirmative), the process determines whether the sound output mode for the printer is set to the silent mode (step S2).

If the sound output mode is set to the silent mode, sound guidance information for the silent mode is acquired by reducing the volume of the sound guidance information output from the sound output unit 9, reducing the length of the sound guidance information by summarizing the details of the sound guidance information, increasing the speech rate of the sound guidance information, switching the output sound to breathed sound (in other words, a whisper or a murmur), or inhibiting low-frequency components of the output sound, prior to output via the sound output unit 9 (step S3).

In contrast, if the sound output mode is not set to the silent mode in step S2, the mode is determined to be a normal mode, and default (or system) set sound guidance information is output from the sound output unit 9 (step S4).

Accordingly, by setting the system to the silent mode, the user can control volume, speech rate and other such characteristics of sound guidance information so as to prevent output of sound. Next, various silent modes that can be set by a user using the system shown in FIG. 1 and examples of operation in the various silent modes will be described.

### First Embodiment

In a silent mode of the first embodiment, the sound guidance information is summarized to reduce its length.

When the silent mode is selected to summarize the sound guidance information, the guidance generation unit 3 edits text stored in the text storage unit 11 to generate the summarized guidance information. For example, sound guidance information such as “add paper to the printer”, is reduced to “add paper” by the guidance generation unit 3.

Similarly, sound guidance information such as “replace blue ink”, is output as “replace blue” when the silent mode is selected.

Accordingly, in the silent mode, summarized guidance information is generated, the sound synthesis unit 8 synthesizes sound guidance information, and the sound output unit 9 outputs the synthesized sound guidance information. Thus, when quiet operation is required during late nights or the like, the length of output time of sound guidance information can be reduced.

### Second Embodiment

In a silent mode of the second embodiment, the speech rate of output sound guidance information is increased.

When this silent mode is set by the silent mode setting unit 2, the speech rate control unit 4 controls sound synthesis processing by the sound synthesis unit 8 and generates sound guidance information for high-rate speech. For example, the speech rate of sound guidance information can be increased from 7 moras per second to 12 moras per second when this mode is selected.

Accordingly, in the silent mode, sound guidance information with high-rate speech is generated. Thus, when quiet operation is required during late nights or the like, the length of output time of sound guidance information can be reduced.

### Third Embodiment

In a silent mode of the third embodiment, the source of output sound guidance information is set to breathed sound source (e.g., whisper or murmur).

When this silent mode is set by the silent mode setting unit 2, the sound source selection unit 5 controls the sound synthesis unit 8 so that output sound guidance information is synthesized to generate breathed sound.

Accordingly, in the silent mode, sound guidance information of breathed sound, such as a whisper or a murmur, is output. Thus, when quiet operation is required during late nights or the like, the loudness can be minimized. For example, sound guidance information for a printer located in a room cannot be heard in an adjoining room.

### Fourth Embodiment

In a silent mode of the fourth embodiment, low-frequency components in an output source of the sound guidance information are eliminated using a low-frequency inhibition filter.

When this silent mode is selected, the low-frequency inhibition unit 6 controls sound synthesis processing by the sound synthesis unit 8 and eliminates the low-frequency components in output sound guidance information using the low-frequency inhibition filter in accordance with the silent mode. For example, FIG. 3 shows an example of a low-frequency inhibition filter used in an information processing device according to the fourth embodiment. In the example shown in FIG. 3, for the synthesized sound guidance information, power at higher frequencies (for example, approximately more than 4 KHz) is maintained, and in contrast, power at lower frequencies (for example, approximately 4 KHz or less) is reduced in accordance with a reduction in the frequency.

Accordingly, in the silent mode, sound guidance information in which low-frequencies unlikely to be shielded by an obstacle such as a wall, is inhibited. The sound guidance information with inhibited low frequency components is then output.

### Fifth Embodiment

In a silent mode of the fifth embodiment, breathed sound guidance generated in the third embodiment is output a plurality of times.

When this mode is selected, the sound output unit 9 outputs the breathed sound guidance information a plurality of times that is generated by the sound synthesis unit 8. For example, for sound guidance information, such as “add paper to the printer”, breathed sound (a whisper or a murmur) is output a plurality of times, such as “add paper to the printer, add paper to the printer . . . ”

Accordingly, in the silent mode, breathed sound guidance, such as a whisper or a murmur, is output a plurality of times. Thus, even when silenced sound guidance information is output, users can catch the sound guidance information. Also, processing for repeating silenced sound guidance information a plurality of times is not limited to breathed sound guidance information. This processing can be applied to a case where the speed of the sound guidance information is increased, the length of the sound guidance information is reduced, low-frequency components are inhibited, and where the volume of sound guidance information is reduced.

### Sixth Embodiment

In a sixth embodiment, an example of a silent mode in which the volume of output sound guidance information is reduced is described.

When a silent mode in which the volume of sound guidance information is reduced is set by the silent mode setting unit 2, the volume control unit 7 reduces the volume of output sound guidance information.

Accordingly, in the silent mode, the volume of sound guidance information is reduced.

### Seventh Embodiment

The aforementioned embodiments are applied to a manner mode (e.g., a vibration mode) of wireless devices such as cellular telephone sets. When a wireless device set is set to a manner mode, an incoming call can be indicated by whispers or mail content may be output using whispers. Also, in the manner mode, the length of received mail may be reduced to be read out by summarizing the details, may be read out at high speed, or may be read at a reduced volume.

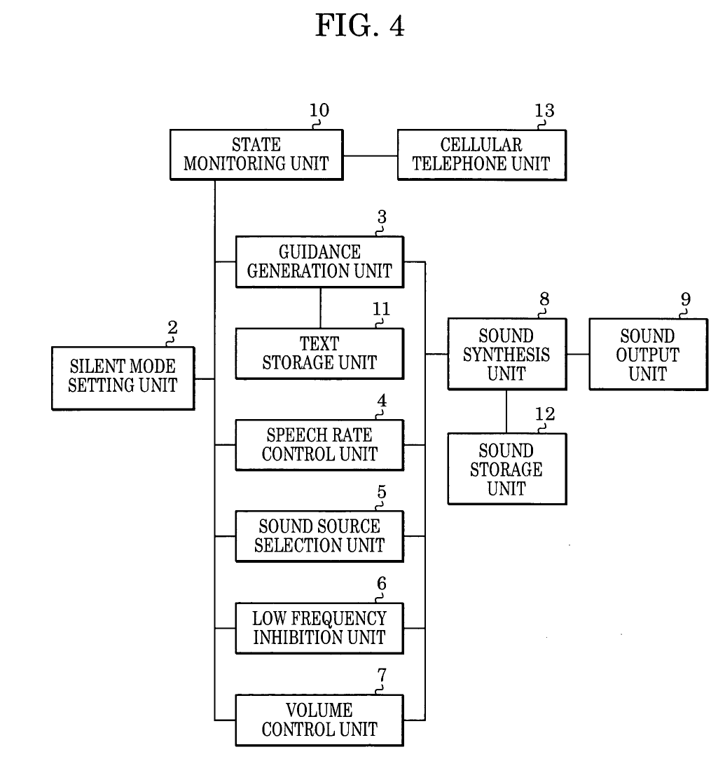

FIG. 4 is a block diagram of an information processing device according to a seventh embodiment of the present invention. The information processing device according to this embodiment is similar to the above described embodiments. Referring to FIG. 4, the cellular telephone unit 13 is a conventional cellular telephone set as improved by the present invention. In this case, the information processing device according to the present invention is incorporated in the cellular telephone set. Also, sound information to be dealt with may be ringing sound, in addition to the operation sound and the sound guidance information described above.

### Eighth Embodiment

Output of the sound guidance information explained in the embodiments may be recorded in advance and may be stored so that processing the sound information generates desired sound guidance information.

### Ninth Embodiment

The present embodiment may incorporate two or more of the aforementioned embodiments. For example, the sound synthesis unit 8 may synthesize the sound guidance information such that the sound guidance information is breathed sound and the volume of the sound guidance information is reduced.

Also, the silent mode of all embodiments may be set for a predetermined fixed time. For example, the system may be automatically set to the silent mode from eight o'clock in the evening to six o'clock in the next morning.

Also, a plurality of levels (stages) may be provided for the silent mode. Not only can users set types of modes, but they can also set the degree of silence in the silent mode. For example, users can set the volume to a level from among a plurality of levels.

Furthermore, the information processing device may further include a display unit. In this case, instead of outputting sound guidance information in the silent mode, the display unit may display text data, signs, and the like so as to inform a user about information relating to an operation state of a system without outputting sound.

The present invention is applicable to a system including a plurality of systems, such as a host computer, an interface system, a reader, a printer, and other systems. Alternatively, the present invention is applicable to a system, such as a copying machine, a facsimile machine, or the like.

Also, the present invention is achieved by supplying a recording medium (or a storage medium) on which program code of software for realizing the functions of the embodiments described above is stored to a system or a system and by reading and executing the program code stored in the recording medium by a computer (or a central processing unit (CPU) or a micro-processing unit (MPU)) of the system or the system. In this case, the program code read from the recording medium attains the functions of the embodiments described above.

The embodiments described above can be attained not only by executing the read program code by the computer but also by performing part or all of the actual processing by an operating system (OS) or the like running on the computer on the basis of instructions of the program code.

Furthermore, the functions of the embodiments described above can also be attained by performing part or all of the actual processing by a CPU or the like arranged in a function expansion card of the computer or a function expansion unit connected to the computer on the basis of instructions of program code read from the recording medium after the program code is written in a memory of the function expansion card or the function expansion unit.

When the present invention is applied to the recording medium described above, program code corresponding to the operation process described above is recorded in the recording medium.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An information processing device, comprising:
monitoring means for monitoring an operation state of a system;
acquisition means for acquiring sound information corresponding to the operation state of the system;
output means for outputting the acquired sound information;
setting means for setting an output mode to a silent mode; and
silencing means for silencing the sound information acquired from the acquisition means when the output mode for the sound information is set to the silent mode,
wherein the output means outputs the silenced sound information in the silent mode.

2. The information processing device according to claim 1, wherein the silencing means reduces the volume of the sound information output from the output means.

3. The information processing device according to claim 1, wherein when the silent mode is set by the setting means, the silencing means increases the output speed of the sound information output from the output means.

4. The information processing device according to claim 1, wherein the sound information is operation sound of the system or sound guidance information corresponding to the operation state of the system.

5. The information processing device according to claim 1, wherein:
the sound information is sound guidance information; and
the silencing means reduces the length of the sound guidance information output from the output means by summarizing the speech details of the sound guidance information.

6. The information processing device according to claim 1, wherein:
the sound information is sound guidance information; and
the silencing means outputs the sound guidance information as breathed sound.

7. The information processing device according to claim 1, wherein:
the sound information is sound guidance information; and
the silencing means inhibits low-frequency components of the sound guidance information output from the output means.

8. The information processing device according to claim 1, wherein the output means outputs the sound information silenced by the silencing means a plurality of times.

9. The information processing device according to claim 1, further comprising:
text storage means for storing text data;
generation means for generating the text data based on the operation state of the system; and
conversion means for converting the text data into sound guidance information.

10. The information processing device according to claim 1, wherein the information processing device is incorporated in the system.

11. The information processing device according to claim 1, wherein the system is a printer.

12. The information processing device according to claim 1, wherein the system is a wireless device set.

13. The information processing device according to claim 12, wherein the sound information is ringing sound or operation sound of the wireless device set.

14. An information processing method for monitoring an operation state of a system and for outputting sound information corresponding to the operation state of the system, comprising:
a setting step of setting an output mode for the sound information to be output to a silent mode;
an acquisition step of acquiring the sound information corresponding to the operation state of the system;
a silencing step of silencing the acquired sound information in case that the output mode for the sound information is set to the silent mode; and
an output step of outputting the silenced sound information.

15. A program for causing a computer for monitoring an operation state of a system and for outputting sound information corresponding to the operation state of the system to execute a process comprising:
a setting step of setting an output mode for the sound information to be output to a silent mode;
an acquisition step of acquiring the sound information corresponding to the operation state of the system;
a silencing step of silencing the acquired sound information in case that the output mode for the sound information is set to the silent mode; and
an output step of outputting the silenced sound information.

16. A computer-readable recording medium storing the program as set forth in claim 15.

17. An information processing device, comprising:
monitoring unit configured to monitor an operation state of an apparatus;
acquisition unit configured to acquire sound information corresponding to the operation state of the apparatus;
output unit configured to output the acquired sound information;
setting unit configured to set an output mode for the sound information output from the output unit to a silent mode; and
silencing unit configured to silence the sound information acquired from the acquisition unit in case that the output mode for the sound information is set to the silent mode,
wherein the output unit configured to output the silenced sound information in case that the output mode for the sound information is set to the silent mode.

18. A method for outputting sound guidance information from a device comprising:
receiving sound guidance information that guides a user to perform tasks on the device or to indicate an event occurrence on the device;
receiving user input to select an output mode for the sound guidance information;
upon user selection, outputting the sound guidance information from the device in the selected output mode, which is configured to control the manner in which the sound guidance information is output.

19. The method of claim 18 wherein the sound guidance information is output in any one or more of the following manners: reducing volume of the sound guidance information output from the device, increasing output speed of sound guidance information output from the device, reducing the length of the sound guidance information output from the output device, outputting the sound guidance information as breathed sound, and inhibiting low-frequency components of the sound guidance information output from the device.

20. The method of claim 18 wherein the device is a printer or wireless communication device.
